(19) United States
(12) Patent Application Publication
(10) Pub. No.: US 2009/0275677 A1
(43) Pub. Date: Nov. 5, 2009

(54) COATING COMPOSITION

(76) Inventor: Ronald R. SAVIN, Palm Springs, CA (US)

Correspondence Address: LADAS & PARRY LLP, 26 WEST 61ST STREET, NEW YORK, NY, 10023, US

(21) Appl. No.: 12/433,981

(22) Filed: May 1, 2009

Related U.S. Application Data
(60) Provisional application No. 61/126,374, filed on May 2, 2008.

(51) Int. Cl. C09D 117/00; C09D 127/12; C09D 5/08

(52) U.S. Cl. 523/219; 524/520; 523/218; 524/526

(57) ABSTRACT

An aqueous coating composition comprising a mixture of recycled rubber particles, and particles at least one of glass or plastic particles, graphite particles and fluorinated resin particles such as polytetrafluoroethytlene and a suspension agent or resin. Various embodiments are useful for coating suitable for highways and parking lots, roofs or swimming pools and metal surfaces and for “rubberizing” marine and other manufactured products.

### RELATED APPLICATION

The present application claims priority from U.S. patent Application Ser. No. 61/126,374 filed on May 2, 2008, the contents of which are incorporated herein by reference.

### FIELD OF THE INVENTION

The present invention relates to coating compositions and in particular to compositions comprising recycled rubber materials.

### BACKGROUND OF THE INVENTION

Rubber dust has been recycled in various forms since the early 1990s. It has been used in coating compositions, for example by addition to asphalt or coal tar for use on asphalt and concrete surfaces. One example of such use has been in rubberized emulsion aggregate slurry (REAS) in which crumb rubber is blended into an asphalt emulsion. REAS has been used in resurfacing of roads. It has, however, proved to be difficult to utilize high percentages of recycled rubber in these compositions because of difficulties in applying compositions containing more than abut 10% recycled rubber to surfaces to be coated.

In my prior U.S. Pat. No. 5,252,632 I described a low cost coating composition comprising light weight hollow glass spheres and a conductive phase.

In my U.S. Pat. No. 7,304,100 I described production of a coating composition by mixing a cellulosic thickener with a latex and glass bubbles.

### SUMMARY OF THE INVENTION

In its broadest aspect, the present invention provides an aqueous coating composition comprising a mixture of recycled rubber particles, particles of glass, graphite and/or a fluorinated resin such as polytetrafluoroethytlene and a suspension agent or resin.

Such compositions have good adhesion and water proofing properties and can be applied using conventional techniques.

Compositions of the invention may be used for a variety of uses including caulks, patio, road, driveway or parking lot surfaces and for use on roofs or in swimming pools. In this context, I have found that coatings made from compositions according to the invention have good resistance to corrosive environments. The precise nature of the composition will depend upon the intended use.

### DETAILED DESCRIPTION OF THE INVENTION

Depending on the intended use, compositions according to the invention typically contain from 10-40% by weight water, 10-40% recycled rubber particles, 0-40% glass or plastic particles, 2-10% graphite and/or fluorinated resin, and from 10-50% of a film forming resin, such as an acrylic resin, provided that in the event that there is less than 10% glass or plastic particles, there is at least 1% fluoronated resin. For certain applications, such compositions may additionally contain particles of fiber glass and speciality chemicals such as preservation chemicals, such as mildewicides, solubilizing agents, antifoam agents such as Byk 024, pigments such as TiO₂, red oxide and yellow and black oxides. Ethylene glycol may also be a useful component when applying the composition to hot or warm surfaces.

For many of the components for use in the present invention, it is desirable that they be present in particles sizes that are as small as commercially practicable. I have therefore indicated that for such materials, the particle size should be less than a specified value. This does not mean that there is no lower limit to the particle sizes that can be used for such materials. As particle sizes of materials become smaller, the difficulties in handling the materials increase and one skilled in the art will recognize the practical lower limits on the particle sizes of the material being used.

Recycled rubber particles for use in the compositions of the present invention may be of a particle size of from 10 to 300 U.S. mesh or even finer, up to 400 mesh, depending on the intended use. I have found that for applications in which my compositions are to be used as caulks or for coating of parking lots or the like, it is possible to use recycled rubber particles having a particle size of 10 to 20 mesh. A particle size of less than 30 mesh may, however, be preferred for some such applications depending on cost. Rubber particles having particle sizes of less than 80 mesh or less than 140 mesh may prove suitable in some applications. Recycled rubber particles of these sizes are available for example from simply pulverizing discarded rubber products such as worn tires, tennis balls and other rubber-containing materials. For more specialist applications, particles of a smaller particle size, below say 200 U.S. mesh, preferably 300 U.S. mesh or finer are preferred. Particles of these fine particle sizes are obtainable, for example by freezing recycled tires and other rubber products and then pulverizing them. For some applications a mixture of particles of different sizes may be appropriate. For example, I have found that for highway and parking lot use a mixture of particles of 10-20 mesh with those having a particle size of less than 30 or 40 mesh may be desirable.

Recycled rubber of the coarser particle sizes employed in the present invention is widely available from a variety of sources. The finer sized particles are available, for example as PolyDyne 80 and PolyDyne 140 from LeHigh Technologies of Tucker, Ga.

Glass or plastic particles for use in the compositions of the present invention are typically of a particle size of less than 100 U.S. mesh (149 microns) more preferably from 3 to 50 microns. Such glass particles may be solid or hollow. Conveniently, some or all of the particles may be obtained from crushed recycled glass or waste fiberglass. I have found that solid glass spheres of a mean particle size of 1 to 50 microns, more preferably 5 to 20 microns are useful in the compositions of the invention in situations where the color of the coating is not important. In cases where it is necessary or desirable to have a light colored appearance, hollow glass spheres of a similar size should be used. Mixtures of particles obtained from waste fiber glass and soda glass, including finely crushed glass, may be used if desired. Suitable glasses include Spheriglass® particles and Sphericell® hollow glass spheres obtainable from Potters Industries Inc of Valley Forge Pa. and recycled low alkali fiber glass particles obtainable from Vitro Minerals of Social Circle Ga. Particularly suitable glasses include Potter's 60s grade microspheres and Vitro Minerals grade LA7. Such materials can also be used in mixtures with each other, for example from 30:70 to 70:30 by weight.

The graphite or fluorinated polymer particles for use in the compositions of the invention typically have a particle size of less than 150 mesh, preferably less than 200 mesh, for example less than 300 mesh. A suitable graphite is 5090 grade graphite obtainable from Superior Graphite Co of Chicago, Ill. A suitable polyfluorinated resin is Teflon®, obtainable from E. I. DuPont de Nemours Inc. of Wilmington, Del.

Compositions according to the invention will typically also contain components to improve their ease of application (in particular the ease with which they can be spread) and adhesion to a substrate (particularly the degree of elasticity they supply to coatings that are subject to temperature variations). A variety of resin products can be used for such purposes. However, I have found that acrylic resins are most suitable for such purposes. Suitable acrylics include Rayflex 303 and Raycryl 61, both of which are obtainable from Specialty Polymers Inc. of Woodburn, Oreg.

Other components that may be used can include suspension agents, for example cellulosic suspension agents such as hydroxyethylcellulose, antifoam agents such as ByK 024 and agents having specialized biocidal properties such as mildewicides or antifouling agents if the coating is to be used in am aqueous environment.

The precise composition employed in any situation will depend upon the nature of the substrate, the degree of durability and to some extent on the esthetics required. For example one will seek to minimize the graphite content and have a corresponding increase the glass content (and in particular use glass in the form of hollow spheres) or include a pigment where there is the need for a light colored finish. Excessive use of pigments such as titanium dioxide should, however, be avoided since they can tend to embrittle the coatings.

One type of composition suitable for highway and parking lot use comprises 25-50, preferably 30-40% by weight acrylic polymer, 5-15%, preferably 8-12% by weight crumb rubber, 5-15%, preferably 8-12%, by weight of rubber particles having a particle size of less than 45 mesh, 12-30%, preferably 15-25% by weight glass particles, 2-10%, preferably 4-8% graphite and up to 1% Teflon®, the balance being predominantly water. In another type of composition for such purposes wherein the glass particles have been replaced by fluorinated resin a higher rubber content is possible, compositions may comprise 25-50, preferably 30-40% by weight acrylic polymer, 5-15%, preferably 8-12% by weight crumb rubber, 15-35%, preferably 18-24%, by weight of rubber particles having a particle size of less than 45 mesh, 2-10%, preferably 4-8% graphite and 1-4% Teflon(g, the balance being predominantly water. This latter type of composition has very good tensile strength and may be deposited in thicknesses of up to 0.5 inch without cracking making it particularly useful for protection of cracks in asphalt and concrete surfaces such as those in parking lots, driveways, roads roofs and other damaged structures.

Coatings for roofs or swimming pools on the other hand may more typically comprise 25-50, preferably 30-40% by weight acrylic polymer, 5-15%, preferably 8-12% by weight rubber particles having a particle size of less than 100 mesh, 12-30%, preferably 15-25% by weight glass particles, and 0.5to 2% Teflon®, the balance being predominantly water.

Coatings for use on metal surfaces such as truck beds may typically comprise 25-55, preferably 35-50% by weight acrylic polymer, 20-40%, preferably 30-35% by weight rubber particles having a particle size of less than 100 mesh, and 1 to 5%, preferably 1.5 to 3% Teflon®, the balance being predominantly water.

Other compositions of the present invention utilize very fine rubber particles produced by pulverizing cryogenically pulverized rubber. Such rubber dusts typically have a particle size of less than 140 U.S. mesh, for example 200 U.S. mesh or finer, commonly less than 85 microns. Compositions utilizing such fine rubber dust may be used in a number of “rubberizing” applications to protect marine and other manufactured product from corrosion damage resulting from contact with moisture. Such compositions typically comprise 25-55, preferably 35-50% by weight acrylic polymer, 20-40%, preferably 30-35% by weight fine rubber dust, and 1 to 5%, preferably 1.5 to 3% Teflon®, the balance being predominantly water. When using such compositions, they are typically applied by conventional coating techniques and may be applied in thicknesses of up to 50 mils, for example from 20 to 50 mils,

Compositions of the present invention may be used to coat a variety of surfaces including metal surfaces, including blasted, phosphate-treated, untreated, or galvanized metal surfaces, including aluminum and steel surfaces concrete surfaces (such as highways, roofs and parking lots), wooden surfaces such as boats, jetties, roofs and decks), plastic surfaces, roofing tiles, porcelain, previously painted surfaces and asphalt surfaces such as highways and parking lots. In the case of metal surfaces, they may be applied even after some corrosion, including both light and heavy rusting has occurred so as to prevent further corrosion as a result of its moisture resistance. A further use of some of the compositions of the present invention in particular those with a high content of fluorinated resin is in providing coatings over materials and articles for which an insulating coating is required during transportation, for example electrical storage batteries that are being transported for recycling. Suitable coatings may be obtained simply by dipping the batteries that are to be recycled in a composition according to the invention.

The method used to apply the composition will depend on the nature of the substrate being coated. However, conventional spay and roller methods and troweling may be used as appropriate. When applying the compositions of the invention by use of rollers, I have found plastic textured rollers to be particularly useful.

Although not needed for every application, I have found that coatings of the present composition can be formed in greater thickness than was possible without cracking when using prior compositions. For example I have been able to produce coatings of up to 50-60 mils. Coatings of this thickness have a variety of applications, for example for use on roofs. Thicker coatings of up to 150 mils can be formed on parking lots and road surfaces where the substrate is asphalt or concrete.

### EXAMPLES

The following are non-limiting examples of compositions according to the invention

### Example 1

### Composition Suitable for Surfacing a Parking Lot or Road

| | | |
|---|---|---|
| Acrylic resin (RayFlex ® 303, Specility Polymers Inc.) | 200 | lbs |
| Acrylic resin (RayCryl ® 61, Specility Polymers Inc.) | 200 | lbs |
| 40 mesh Recycled rubber particles (Polydyne 40, Lehigh | 125 | lbs |
| Technologies) | | |
| 10-20 mesh crumb rubber | 125 | lbs |
| Low alkali glass filler (LA7, VitroMineral) | 166 | lbs |
| Hollow glass spheres (60s, Potters) | 37.5 | lbs |
| Graphite (5090, Superior Graphite) | 50 | lbs |
| Teflon ® (707, Shamrock) | 5 | lbs |
| Antifoam (Byk 024, Byk Chemical) | 8 | lbs |
| 250MR (Natrosol Hercules) | 3 | lbs |
| Ethylene glycol | 50 | lbs |
| Water | 250 | lbs |
| Total | 1214 | lbs |

The composition is made by mixing the acrylic resins with water and then slowly adding the recycled rubber particles, the glass particles, the graphite particles and the Teflon® particles. The materials are dispersed rapidly for 20 minutes. After the rubber and glass particles have been homogenized, the antifoam is added to remove foam that has been generated during the mixing. When visible foam has been dispersed, the 250MR is gently added to adjust the viscosity so that the glass particles are retained within the composition and do not float to the surface.

The composition remains stable for six months and may be applied to parking lots, driveways and patios by roller, brush spray or troweling as appropriate.

### Example 2

### Composition Suitable for Caulking or Surfacing a Parking Lots

| | | |
|---|---|---|
| Acrylic resin (RayFlex ® 303, Specility Polymers Inc.) | 200 | lbs |
| Acrylic resin (RayCryl ® 61, Specility Polymers Inc.) | 200 | lbs |
| 40 mesh Recycled rubber particles (Polydyne 40, Lehigh | 150 | lbs |
| Technologies) | | |
| 30 mesh crumb rubber | 150 | lbs |
| Low alkali glass filler (LA7, VitroMineral) | 166 | lbs |
| Hollow glass spheres (60s, Potters) | 37.5 | lbs |
| Graphite (5090, Superior Graphite) | 50 | lbs |
| Teflon ® (707, Shamrock) | 5 | lbs |
| Antifoam (Byk 024, Byk Chemical) | 8 | lbs |
| 250MR (Natrosol Hercules) | 3 | lbs |
| Ethylene glycol | 50 | lbs |
| Water | 100 | lbs |
| Total | 1117 | lbs |

The composition is prepared in a similar manner to Example 1.

The composition remains stable for six months and may be applied to parking lots, driveways and patios by roller, brush spray or trowelling as appropriate.

### Example 3

Composition Suitable for Surfacing a Roof

| | | |
|---|---|---|
| Acrylic resin (RayFlex ® 303, Specility Polymers Inc.) | 200 | lbs |
| Acrylic resin (RayCryl ® 61, Specility Polymers Inc.) | 200 | lbs |
| 140 mesh Recycled rubber particles (Polydyne 140, Lehigh | 100 | lbs |
| Technologies) | | |
| Low alkali glass filler (LA7, VitroMineral) | 100 | lbs |
| Hollow glass spheres (60s, Potters) | 100 | lbs |
| Teflon ® (707, Shamrock) | 10 | lbs |
| Antifoam (Byk 024, Byk Chemical) | 3 | lbs |
| 250MR (Natrosol Hercules) | 3 | lbs |
| Titanium dioxide (DuPont) | 100 | lbs |
| Water | 250 | lbs |
| Total | 1066 | lbs |

The composition is prepared in a similar manner to Example 1.

The composition remains stable for 6 months and may be applied to patios, parking lots, driveways, roofs and swimming pools using appropriate application equipment including textured rollers, brushes, airless spray guns or toweling with large or small trowels.

### Example 4

### Rubber Caulk (High Strength)

| Volume | Lbs | Material | Supplier |
|---|---|---|---|
| 10.2 | 85 | H₂0 | |
| 1 | 5 | W-28 wetting agent | |
| | 4 | BYK 024 Anti foam | BYK Chemie |
| 1.2 | 20 | 807 (Teflon) | Shamrock Inc. |
| 2.7 | 50 | 5020 Graphite | Superior graphite |
| 40 | 350 | Acrylic 61 | Specialties |
| | | | Polymers |
| 17 | 150 | Acrylic 303 (elastomeric) | Specialties |
| | | | Polymers |
| 0.7 | 6 | Natrosol250M.R (thickener) | Hercules Inc. |
| 11 | 110 | Rubber dust (80 mesh) | Lehigh Industries |
| 11 | 110 | Rubber dust (10-20 mesh) | Bas Inc. |
| 11 | 110 | Rubber dust (1-2 mesh) | Bas Inc. |

Such composition has excellent tensile strength permitting depositions of up to 0.5 inch without cracking.

### Example 5

### Marine and Industrial Hyperflex (High End)

| Volume | Lbs | Material | Supplier |
|---|---|---|---|
| 18 | 180 | H₂0 | |
| 2 | 12 | Vantex-T coalescent | Taminco Inc. |
| | 4 | W-28 | |
| | 4 | BYK 024 Anti foam | BYK Chemie |
| 1.2 | 20 | 807 Teflon | Shamrock |
| 0.7 | 5 | 250 MR thickener | Hercules lnc. |
| 53 | 475 | Rayflex 61 acrylic | Specialties |
| | | | Polymers |
| 30 | 300 | Fine rubber dust 300* | Lehigh Industries |

*Having a particle size 275-325 U.S. mesh.

This composition is of use as a “rubberizing” composition for application to substrates requiring a protective coating for protection from moisture,

### Example 6

### Hyperliner (Bedliner)

| Volume | Lbs | Material | Supplier |
|---|---|---|---|
| 21.5 | 180 | H₂0 | |
| 1.5 | 12 | Vantex-T coalescent | Taminco Inc. |
| | 4 | W-28 | |
| | 4 | BYK 024 anti foam | BYK Chemie |
| 1.2 | 20 | 807 Teflon (R) | Shamrock |
| 0.6 | 5 | 250 MR thickener | Hercules Inc. |
| 51 | 450 | Rayflex 61 Acrylic resin | Specialties |
| | | | Polymers |
| 32.5 | 325 | Rubber dust (80 mesh) | Lehigh |
| | | | Industrie |

This composition is of particular use for providing a coating on a metal surface such as a truck bed.

1. An aqueous coating composition comprising a mixture of recycled rubber particles, and particles at least one of glass or plastic particles, graphite particles and fluorinated resin particles such as polytetrafluoroethytlene and a suspension agent or resin.

2. An aqueous coating composition as claimed in claim 1, comprising 10-40% by weight water, 10-40% recycled rubber particles, 0-40% glass or plastic particles, 2-10% graphite and/or fluorinated resin, and from 10-50% of a film forming resin, such as an acrylic resin, provided that in the event that there is less than 10% glass or plastic particles, there is at least 1% fluoronated resin.

3. An aqueous coating composition as claimed in claim 1, wherein said rubber particles comprise 10-40% of the composition.

4. An aqueous coating composition as claimed in claim 1, comprising 10-40%. glass or plastic particles.

5. An aqueous coating composition as claimed in claim 1, comprising at least one of 2-10% graphite and fluorinated resin.

6. An aqueous coating composition as claimed in claim 1, wherein said recycled rubber particles are of a particle size of from 10 to 400 U.S. mesh.

7. An aqueous coating composition as claimed in claim 6, wherein said recycled rubber particles comprise particles of a particle size of 10 to 20 U.S. mesh.

8. An aqueous coating composition as claimed in claim 1, wherein said recycled rubber particles comprise particles of a size less than 300 U.S. mesh.

9. An aqueous coating composition as claimed in claim 1, wherein said glass or plastic particles are of a particle size of less than 100 U.S. mesh.

10. An aqueous coating composition as claimed in claim 1, wherein said glass or plastic particles comprise particles of a mean size of 5 to 20 microns.

11. An aqueous coating composition as claimed in claim 1, wherein said glass or plastic particles comprise particles that are hollow.

12. An aqueous coating composition as claimed in claim 1, wherein said glass or plastic particles comprise a mixture of hollow and solid particles in a weight ratio of from 70:30 to 30:70.

13. An aqueous coating composition as claimed in claim 1, wherein said glass or plastic particles comprise recycled fiberglass particles.

14. An aqueous coating composition as claimed in claim 1, which comprises graphite particles.

15. An aqueous coating composition as claimed in claim 13, wherein said graphite particles comprise particles having a particle size of less than 150 U.S. mesh.

16. An aqueous coating composition as claimed in claim 1, which comprises fluorinated polymer particles.

17. An aqueous coating composition as claimed in claim 1, which comprises an acrylic resin.

18. A coating composition as claimed in claim 1, suitable for highways and parking lots which comprises 25-50% by weight acrylic polymer, 5-15% by weight crumb rubber, 5-15%, by weight of rubber particles having a particle size of less than 25 mesh, 12-30%, glass particles, 2-10%, graphite particles and up to 1% Teflon®, the balance being predominantly water.

19. A coating composition as claimed in claim 1, comprising 25-50, by weight acrylic polymer, 5-15%, by weight crumb rubber, 15-35%, by weight of rubber particles having a particle size of less than 45 mesh, 2-10% by weight graphite and 1-4% Teflon®, the balance being predominantly water.

20. A coating composition as claimed in claim 1, suitable for roofs or swimming pools which comprises 25-50% by weight acrylic polymer, 5-15% by weight rubber particles having a particle size of less than 100 mesh, 12-30% 15-25% by weight glass particles, and 0.5 to 2% Teflon®, the balance being predominantly water.

21. A coating composition as claimed in claim 1, suitable for coating metal or use on metal surfaces comprising 25-55, by weight acrylic polymer, 20-40% by weight rubber particles having a particle size of less than 100 mesh, and 1 to 5%, Teflon®, the balance being predominantly water.

22. A coating composition as claimed in claim 1, suitable for “rubberizing” marine and other manufactured products for protection from corrosion damage resulting from contact with moisture comprising 25-55% by weight acrylic polymer, 20-40%, by weight fine rubber dust, and 1 to 5% Teflon®, the balance being predominantly water.
